(19) United States
(12) Patent Application Publication
(10) Pub. No.: US 2004/0016554 A1
(43) Pub. Date: Jan. 29, 2004

(54) Multi-function farm implement for treating soil

(76) Inventor: Kevin G. McDonald, Modesto, CA (US)

Correspondence Address: Stephen T. Sullivan, SULLIVAN LAW GROUP, Suite 1140, 1850 North Central Avenue, Phoenix, AZ, 85004-4586, US

(21) Appl. No.: 10/426,920

(22) Filed: Apr. 29, 2003

Related U.S. Application Data
(63) Continuation-in-part of application No. 10/126,433, filed on Apr. 19, 2002.

(51) Int. Cl. A01B 49/02

(52) U.S. Cl. 172/146

(57) ABSTRACT

The farm implement of this invention is movable across ground along a direction of travel for tillage. The farm implement includes at least a frame and a multi-disc unit. The multi-disc unit includes pluralities of first and second discs, each having a ground-engaging outer periphery defining a plane angled acutely relative to the direction of travel. The first discs are angled to an opposite side of the direction of travel than the second discs. Positioned between the plurality of first discs and the plurality of second discs is a first flow controller assembly, preferably a coulter assembly. Positioned behind the plurality of second discs is a second flow controller assembly, preferably a coulter assembly.

### RELATED APPLICATION

This is a continuation-in-part of U.S. patent application Ser. No. 10/126,433, filed on the U.S. Patent & Trademark Office on Apr. 19, 2002, the disclosure of which is incorporated herein by reference.

### BACKGROUND OF THE INVENTION

1. Field of the Invention

This invention relates to the field of farm equipment for breaking and mixing soil, especially for preparing a seedbed for planting. Particularly preferred aspects of the invention relate to the field of farm implements having multiple cultivating devices that manipulate the soil in distinct ways to collectively form a level seedbed with a consistent depth by a single pass of the implement. This invention further relates to the planting of crops and incorporation of fertilizers and herbicides into a seedbed.

2. Description of the Related Art

Farmers for years have been searching for an implement that would allow them to convert compacted soil into a level seedbed with a consistent depth for providing excellent conditions for planting crops. It has also been desirable for grass or stubble growing or disposed on top of the soil to be worked into and uniformly through the seedbed so that it does not interfere with a planting implement passing through the seedbed.

Farmers have used a variety of implements in attempts to provide their fields with a level seedbed of a consistent depth, be it loose or firm. For instance, a farmer might have first worked the entire field with a v-chisel, chisel plow or disk implement to loosen and break compacted soil. The farmer might then have worked the entire field with an implement having a plurality of S-tines, C-shanks, or other blades to further mix the soil and attempt to break down some of the larger soil clods. Thereafter, a farmer sometimes might have used an implement with a reel having a plurality of blades for breaking clods into smaller sizes and chopping up the debris still remaining on the top of the soil. In yet a fourth pass over the entire ground, a farmer might have used an implement having rows of rollers, each roller having a plurality of longitudinal blades disposed about its periphery for mixing and blending the soil conditioned from the previous passes through the field with the other implements. Such rollers serve to position and incorporate the debris under and within the seedbed. A fifth pass may then be made with a land planer or the like for leveling the field.

Multiple passes with different implements as described above do not necessarily provide a level seedbed with a consistent depth. Further, the multiple passes can cause compaction of the soil, especially moist soil. Compaction of soil can reduce crop yields. In conducting multiple passes with different implements, each of the implements being used typically bounces and rocks as it is pulled across the field. Thus, the first implement that is pulled across the field may not always have a consistent cultivation depth, but may have a cultivation depth that varies depending upon the location in the field and the compaction of the ground. As a second implement is pulled through the field thereafter, the second implement may also rock and bounce as it is being pulled if the first implement had been non-uniformly treated the field. As is apparent, the second implement may not rock and bounce in a manner identical to that of the first implement. Thus, the cultivation depth of each implement is likely to be different and the conditioning of the soil provided by the implements is likely to be non-uniform because of the above-described factors. The inconsistencies in the soil condition and seedbed depth may be multiplied each time a pass is made through a field with a different implement. Additionally, portions of the field that are subjected to multiple passes of tractor tires may exhibit large discrepancies of compaction and seedbed depth compared to portions of the field over which the tractor tires do not pass.

Attempting to set separately operated implements to each operate at the exact same depth is likely to be very difficult, if not impossible. Each implement will likely have a different depth-setting structure with different adjustments and calibrations. Therefore, the use of multiple passes with multiple implements is, in most instances, impractical for preparing a level seedbed with a consistent depth.

Further, the multiple-pass, multiple-implement techniques described above do not allow for efficient incorporation of fertilizer or fumigants or the like into a seedbed. More particularly, if a fertilizer or seed is applied to the top of the soil and not incorporated within a particular period of time, the effectiveness of the fertilizer or fumigants can be lost. Therefore, fertilizer or the like applied between passes of an implement can result in loss of effectiveness of the fertilizer if the second pass is not made expeditiously. Factors such as weather and equipment maintenance may impede a farmer from being able to make an additional pass within the desired amount of time.

Other implements have been used in attempts to solve the problems described above. One such implement is disclosed in U.S. Pat. No. 5,622,227 and comprises a multi-functioned farm implement for treating soil. The multi-functioned farm implement comprises a plurality of rows of different cultivating devices mounted on a frame that is pulled by a tractor or other vehicle of suitable horsepower. Among the cultivating devices that may be used with the '227 farm implement are the following: a cultivating device which is commercially available under the name “DYNA-DRIVE” manufactured by Bomford Turner LTD of Evesham Worcs., England; S-tines; chopping and breaking reels; and finishing reels. Although the '227 patent farm implement has proven to be much more effective than the conventional techniques and implements described above, the '227 patent farm implement does have some drawbacks. In particular, it has been found that the '227 patent farm implement has limited penetration into compacted ground of about 15 cm (6 inches) deep, making the implement principally useful for secondary tillage. Additionally, it is difficult to variably and individually control the penetration depth of each of the cultivating devices of the '227 patent farm implement, thus restricting to some degree the ability to tailor the farm implement for particular fields or applications.

Another implement that has been used is the Wishek 3. Model Disc, which is commercially available from Wishek Steel and Manufacturing. This implement comprises a frame, a front row of concave discs mounted rotatably on the frame, and a rear row of concave disc mounted rotatably on the frame and spaced behind the front row of concave discs. The concave faces of the front discs and the rear discs face in generally opposite directions to each other, and are exposed yet offset by a predetermined angle to the direction of travel. Although this implement was designed for primary tillage, it has been found that operation of this implement at high rates (for example, 5 mph or higher) can lead to inconsistent treatment of fields and does not always prepare the desired level seedbed of consistent depth needed for planting. Soil tends not to flow smoothly through the implement, but to accumulate between the discs. As a consequence, soil displaced by the front row of discs may not flow consistently into the rear row of discs, so that the rear row of discs has limited effectiveness in inverting and further breaking the soil. Moreover, accumulation of soil between discs can deleteriously affect the performance of the second discs. Accordingly, debris such as stubble or grass remains on the top of the soil after the implement has passed, thus, interfering with planting.

### OBJECTS OF THE INVENTION

Accordingly, one object of this invention is to provide a farm implement capable of primary tillage or secondary tillage for preparing a level seedbed with a substantially consistent depth from untreated compact soil in a single pass.

It is another object of this invention to provide a farm implement that has interchangeable parts to allow switching between primary tillage and secondary tillage.

Additional objects and advantages of the invention will be set forth in the description that follows, and in part will be apparent from the description, or may be learned by practice of the invention. The instrumentalities and combinations pointed out in the appended claims may be used to realize and obtain one or more of these and objects and advantages of the invention.

### SUMMARY OF THE INVENTION

To achieve the foregoing objects, and in accordance with the purposes of the invention as embodied and broadly described in this document, according to a first aspect of this invention there is provided a farm implement movable across ground along a direction of travel for tillage of the ground. The farm implement comprises a frame and a multi-disc unit coupled to the frame. The multi-disc unit comprises a plurality of first discs, preferably arranged along a first row, each having a first ground-engaging outer periphery. Each first ground-engaging outer periphery generally lies in a respective first plane angled acutely relative to the direction of travel. The multi-disc unit further comprises a plurality of second discs, preferably arranged along a second row that is behind the first row along the direction of travel, each of the second discs having a second ground-engaging outer periphery. Each second ground-engaging outer periphery generally lies in a respective second plane angled acutely to an opposite side of the direction of travel than the first planes. The first and second generally transverse directions are preferably in generally opposite directions to each other.

Preferably yet optionally, the first ground-engaging outer peripheries of the first discs each comprise a plurality of notches extending substantially radially inward relative to the first discs and spaced circumferentially relative to each other. Likewise, the second ground-engaging peripheries of the second discs preferably yet optionally each comprise a plurality of notches extending substantially radially inward relative to the second discs and spaced circumferentially relative to each other. The first and second rows of discs are preferably linear and preferably substantially perpendicular to the direction of travel. It is also preferable that each of the first discs and each of the second discs have a respective concave face exposed to the direction of travel.

In a preferred embodiment of the first aspect of the invention, the first planes and the second planes are offset relative to the direction of travel by 10 degrees to 25 degrees, more preferably about 17 to about 18 degrees.

The multi-disc unit of the first aspect of the invention still further comprises a first flow controller assembly situated between the plurality of first discs and the plurality of second discs, and a second flow controller assembly situated behind the plurality of second discs. The first flow controller assembly preferably knocks down ground tilled by the first discs towards the ground for tillage by the second discs. Still more preferably, the first flow controller assembly also engages the ground tilled by the first discs for chopping and breaking the soil. The second flow controller assembly preferably knocks down ground tilled by the second discs.

In another preferred embodiment of the first aspect of the invention, the first discs are mounted at the front end of the frame, without any cultivating devices situated in front of the first discs along the direction of travel. The flow controller assembly, the first discs, and the second discs may rotate at the same or different rotational speed, depending, for example, upon the diameter of the discs and flow controller assembly.

In a particularly preferred embodiment of the first aspect of the invention, either or both of the first and second flow controller assemblies comprise a respective coulter shaft and a respective plurality of rotatable coulter blades spaced apart axially relative to one another along the axis of the coulter shaft, each of the coulter blades having a ground-engaging outer periphery. The outer peripheries of the coulter blades define respective third planes that are preferably parallel to the direction of travel. The multi-disc unit preferably has equal numbers of first discs, second discs, and coulter blades in said flow controller assembly.

According to another preferred embodiment of the first aspect of the invention, either or both of the first and second flow controller assemblies comprises a respective reel assembly, the reel assembly comprising a rotatable reel shaft and a plurality of elongated blades. The longitudinal blades are spaced circumferentially about the periphery of the reel shaft along a helical pattern and have a ground-engaging edge for chopping debris and breaking soil clods.

According to another preferred embodiment of the first aspect of the invention, a coulter assembly is coupled to the frame and situated behind, and more preferably immediately behind, the first flow controller assembly along the direction of travel. The coulter assembly comprises a coulter shaft and a plurality of rotatable coulter blades spaced apart axially relative to one another along the axis of the coulter shaft, each of the coulter blades having a ground-engaging outer periphery.

According to still another preferred embodiment of the first aspect of the invention, a reel assembly is coupled to the frame and situated behind, and more preferably immediately behind, the second flow controller assembly along the direction of travel. The reel assembly comprises a rotatable reel shaft having a periphery, and a plurality of elongated blades. The longitudinal blades are spaced circumferentially about the periphery of the reel shaft along a helical pattern and have a ground-engaging edge for chopping debris and breaking soil clods.

According to yet another preferred embodiment of the first aspect of the invention, the farm implement further comprises a plurality of rows of at least one member selected from the group consisting of chisel shanks and tines supported by the frame. The rows are disposed behind the plurality of second discs along the direction of travel. Each of the chisel shanks/tines has a respective edge portion distal to the frame for engaging the ground. Preferably yet optionally, the chisel shanks/tines are detachable from and reattachable to the frame.

In accordance with a second aspect of this invention, there is provided a farm implement movable across ground along a direction of travel for tillage of the ground. The farm implement comprises a frame, a forward multi-disc unit coupled to the frame, and a rearward multi-disc unit coupled to the frame and arranged behind the forward multi-disc unit along the direction of travel. The forward multi-disc unit comprises a plurality of rotatable first discs, a plurality of rotatable second discs, and first and second flow controller assemblies. The rotatable first discs have respective first ground-engaging outer peripheries for engaging and tilling the ground. Each of the first ground-engaging outer peripheries define a respective first plane angled acutely relative to the direction of travel. The plurality of rotatable second discs are arranged behind the first discs along the direction of travel and have respective second ground-engaging outer peripheries for engaging and tilling the ground tilled by the plurality of rotatable first discs. Each of the second ground-engaging outer periphery define a respective second plane angled acutely to an opposite side of the direction of travel than the first planes. The first flow controller assembly is situated between the plurality of first discs and the plurality of second discs for knocking down ground tilled by the first discs for tillage by the second discs. The second flow controller assembly is situated behind the plurality of second discs for knocking down ground tilled by the second discs. The rearward multi-disc unit comprises a plurality of rotatable third discs, a plurality of rotatable fourth discs, and third and fourth flow controller assemblies. The rotatable third discs have respective third ground-engaging outer peripheries for engaging and tilling the ground. Each of the third ground-engaging outer peripheries define a respective third plane angled acutely relative to the direction of travel. The rotatable fourth discs are arranged behind the third discs along the direction of travel and have respective fourth ground-engaging outer peripheries. Each of the fourth ground-engaging outer periphery define a respective fourth plane angled acutely to an opposite side of the direction of travel than the third planes for directing the tilled ground in a fourth generally transverse direction relative to the direction of travel. The third flow controller assembly is situated between the plurality of third discs and the plurality of fourth discs for knocking down ground tilled by the third discs for tillage by the fourth discs. The fourth flow controller assembly is situated behind the plurality of fourth discs for knocking down ground tilled by the fourth discs.

Preferably yet optionally, the ground-engaging outer peripheries of at least one member selected from the group consisting of, and optionally a plurality or all, the first discs, the second discs, the third discs, and the fourth discs comprise a plurality of notches extending substantially radially inward and spaced circumferentially relative to each other. The first, second, third and fourth rows of discs are each preferably linear and preferably substantially perpendicular to the direction of travel. It is also preferable that each of the first discs, second discs, third discs, and fourth discs have a respective concave face exposed to the direction of travel.

In a preferred embodiment of the second aspect of the invention, the first, second, third, and fourth planes are offset relative to the direction of travel by 10 degrees to 25 degrees, more preferably about 17 to about 18 degrees.

In another preferred embodiment of the second aspect of the invention, the first discs are mounted at the front end of the frame, without any cultivating devices situated in front of the first discs along the direction of travel. The first discs, the second discs, and the first and second flow controller assemblies may optionally rotate at the same or different rotational speed. Similarly, the third discs, the fourth discs, and the third and fourth flow controller assemblies may optionally rotate at the same or different rotational speeds.

In a particularly preferred embodiment of the second aspect of the invention, at least one member selected from the group consisting of, and optionally a plurality or all of the first, second, third, and fourth flow controller assemblies comprise a respective coulter shaft and a respective plurality of rotatable coulter blades spaced apart axially relative to each other along the axis of the coulter shaft, each of the coulter blades having a ground-engaging outer periphery. The outer peripheries of the coulter blades define respective planes that are preferably parallel to the direction of travel.

According to another preferred embodiment of the second aspect of the invention, at least one member selected from the group consisting of, and optionally a plurality or all of the first, second, third, and fourth flow controller assemblies comprise a respective reel assembly, the reel assembly comprising a rotatable reel shaft and a plurality of elongated blades. The longitudinal blades are spaced circumferentially about the periphery of the reel shaft along a helical pattern and have a ground-engaging edge for chopping debris and breaking soil clods.

According to another preferred embodiment of the second aspect of the invention, a coulter assembly is coupled to the frame and situated behind, and more preferably immediately behind, the first flow controller assembly along the direction of travel. The coulter assembly comprises a coulter shaft and a plurality of rotatable coulter blades spaced apart axially relative to one another along the axis of the coulter shaft, each of the coulter blades having a ground-engaging outer periphery.

According to another preferred embodiment of this aspect of the invention, a reel assembly is coupled to the frame and situated behind the second flow controller assembly along the direction of travel. The reel assembly comprises a rotatable reel shaft having a periphery, and a plurality of elongated blades. The longitudinal blades are spaced circumferentially about the periphery of the reel shaft along a helical pattern and have a ground-engaging edge for chopping debris and breaking soil clods.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In the drawings:

FIG. 1 is a side elevation view of a farm implement embodying aspects of a first preferred embodiment of the present invention;

FIG. 2 is an overhead view of the farm implement of FIG. 1;

FIG. 3 is a side elevation view of a farm implement embodying aspects of a second preferred embodiment of the invention;

FIG. 4 is a side elevation view of a farm implement embodying aspects of a third preferred embodiment of the present invention;

FIG. 5 is an overhead view of a portion of the farm implement of FIG. 4;

FIG. 6 is an overhead view of a frame structure according to an embodiment of the present invention;

FIG. 7 is an overhead view of a central section of the frame structure of FIG. 6;

FIG. 8 is a side elevation view of a rear lateral support bracket of the frame structure of FIG. 7;

FIG. 9 is an overhead view of a wing section of the frame structure of FIG. 6;

FIG. 10 is a sectional end view taken along sectional line X-X of FIG. 6 showing the wing sections in a lowered, deployed state;

FIG. 11 is a sectional end view taken along sectional line XI-XI of FIG. 6 showing the wing sections in a raised, stowed state;

FIG. 12 is a front fragmentary view of a portion of a multi-disc unit of the farm implements of FIGS. 1-5, with modifications;

FIG. 13 is a top plan view of a coulter assembly of the farm implement;

FIG. 14 is a front elevation view of the coulter assembly of FIG. 13;

FIG. 15 is a side elevation view of the coulter assembly of FIGS. 13 and 14;

FIG. 16 is a front elevation view of a mid-reel of the farm implement of the second and third embodiments of the invention;

FIG. 17 is a side elevation view of the mid-reel of FIG. 16;

FIG. 18 is an isometric view of a chisel shank of the farm implement;

FIG. 19 is a side elevation view of the chisel shank of FIG. 18;

FIG. 20 is a side elevation view of a basket unit;

FIG. 21 is a rear isometric view of the basket unit of FIG. 20 and a finishing roller; and

FIG. 22 is a schematic view of a bearing arrangement.

### DETAILED DESCRIPTION OF PREFERRED EMBODIMENTS AND PREFERRED METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

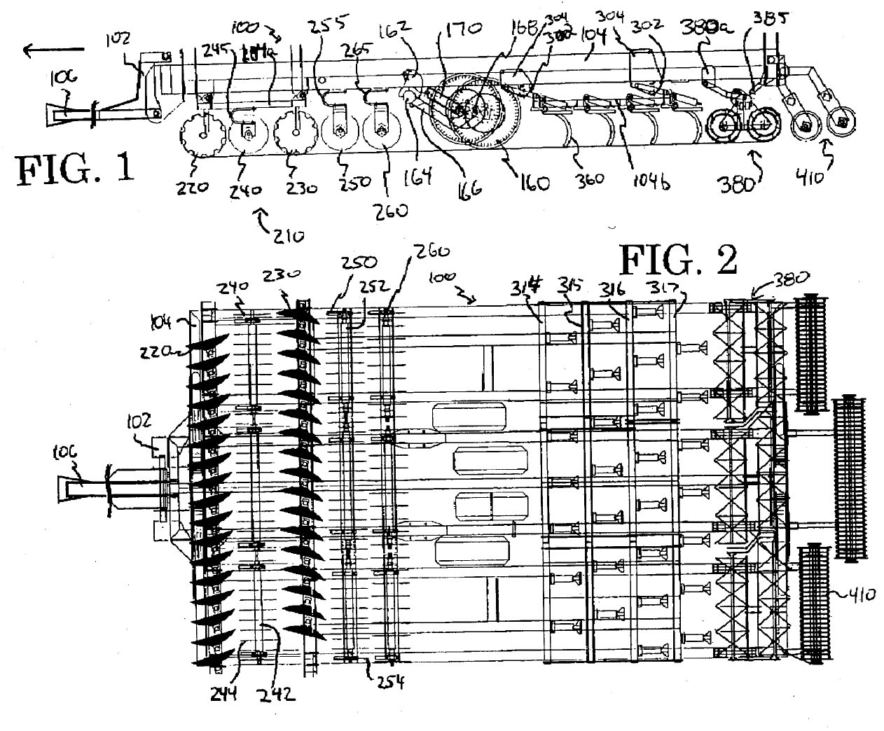

Turning now to the drawings in greater detail and initially to FIGS. 1 and 2, a farm implement according to a first preferred embodiment of the present invention is designated generally by the numeral 100. The farm implement 100 has a hitch portion 102 and a rigid frame 104. The frame 104 is preferably made out of hollow steel beams with rectangular cross sections. The hitch portion 102 is pivotally attached to forward coupling structure, generally designated by reference numeral 106. The forward coupling structure 106 is attachable to the hitching structure of a tractor or other vehicle (not shown) for pulling the farm implement 100 across ground or soil along a direction of travel, as indicated by the arrow in FIG. 1.

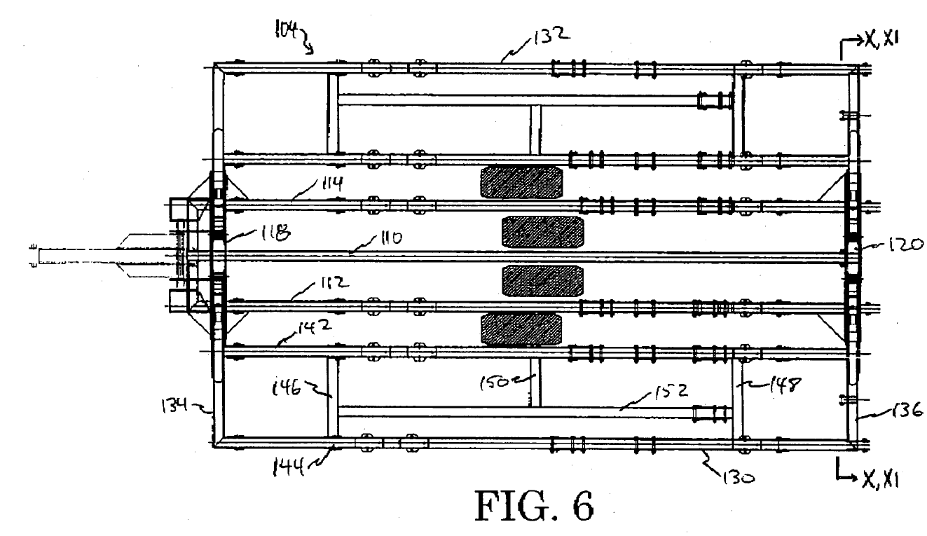

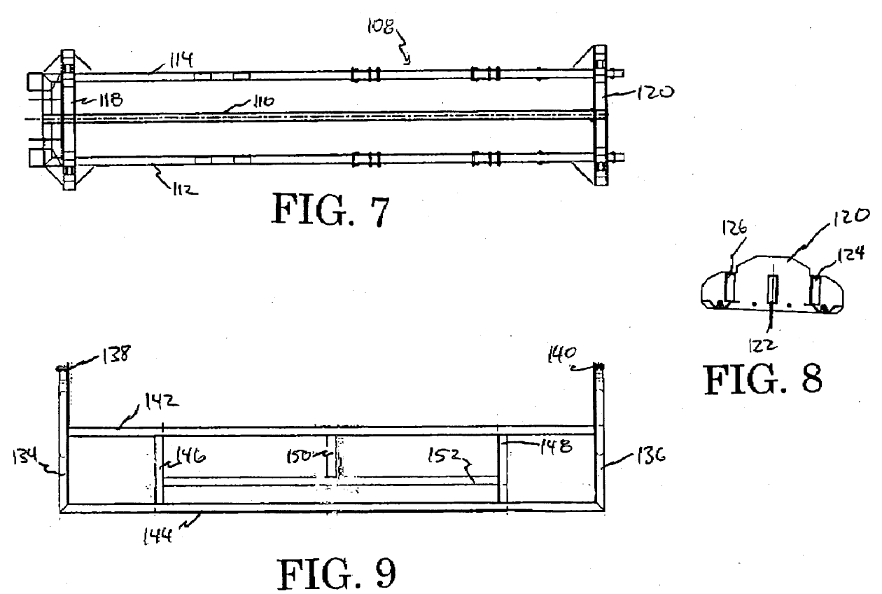

As shown in FIGS. 6-9, the frame 104 comprises a central frame structure generally designated by reference numeral 108. The central frame structure 108 comprises a central longitudinal support beam 110. Positioned on opposite sides of and equidistant relative to the central longitudinal support beam 110 are side longitudinal support beams 112 and 114. The central frame structure 108 further comprises a front lateral support bracket 118 and a rear lateral support bracket 120, the latter of which is shown in greater detail in FIG. 9. The lateral support brackets 118 and 120 contain three flanges or openings 122, 124, and 126 (FIGS. 8, 10, and 11) for respectively supporting the central longitudinal support beam 110 and the side longitudinal support beams 112 and 114. The side longitudinal support beams 112 and 114 extend between the front and rear lateral support brackets 118 and 120. The beams 110, 112, and 114 and brackets 118 and 120 are arranged in substantially the same horizontal plane and are connected together by welds, bolts and/or other suitable fasteners. The functions of the front and rear lateral support brackets 118 and 120 will be described in detail below.

Although not shown in the figures, the frame 104 may carry a fertilizer or herbicide tank and fertilizer spraying equipment. The frame 104 may also carry a planter hopper with feed distribution capability. The spraying equipment can be coupled to the frame 104 in front of or behind any of the cultivating devices, such devices being more fully described below.

Referring to FIGS. 6 and 9, the frame 104 further includes first and second folding frame wings 130 and 132. The first and second frame wings 130 and 132 are located on opposite sides of the central frame structure 108. The frame wings 130 and 132 are essentially mirror images of one another. Accordingly, in the interest of brevity, only the first frame wing 130 will be described with reference to FIG. 9. The first frame wing 130 comprises a front lateral wing beam (or member) 134 and a rear lateral wing beam (or member) 136 having end portions pivotally coupled to the front and rear lateral support brackets 118 and 120 at reference points 138 and 140, respectively. Longitudinal beams 142 and 144 connect the front and rear lateral wing beams 134 and 136. Crossbeams 146, 148, and 150 and longitudinal beam 152 provide added stability to the frame wing 130.

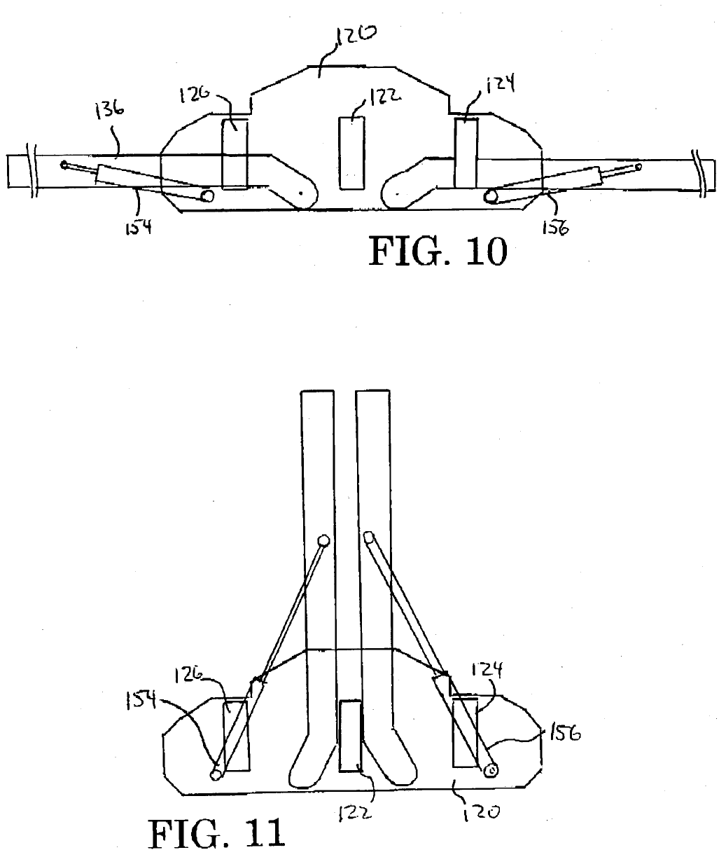

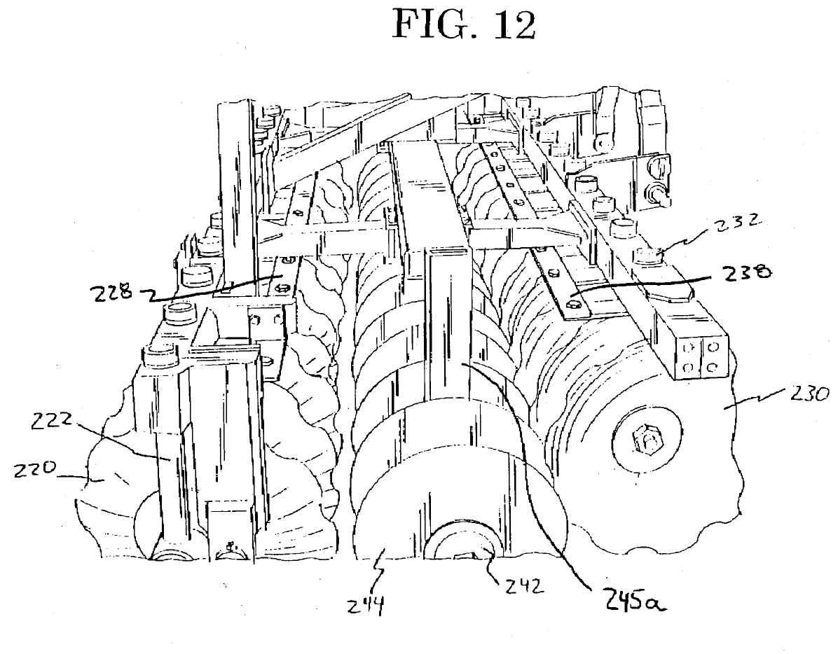

In a preferred embodiment, the first and second frame wings 130 and 132 may be raised from their operative (lowered) position, which is substantially parallel to the ground or horizontal and shown in FIG. 10, to an angle of at least 45 degrees, more preferably about 90 degrees, as shown in FIG. 11. Hydraulic cylinders 154 and 156 each have one end pivotally connected to rear lateral support bracket 120 and the other of their ends pivotally connected to a respective rear lateral wing beam 136. Although not shown in the drawings, similar hydraulic cylinders may be used for connecting the front lateral support bracket 120 to a respective front lateral wing beam 134. When the cylinders 154 and 156 are depressurized into the non-activated or retracted positions shown in FIG. 10, the first and second frame wings 130 and 132 are substantially parallel to the ground. Actuating (or extending the rods of) the cylinders 154 and 156 via pressurization causes the first and frame wings 130 and 132 to rise into their folded positions shown in FIG. 11. The hydraulic cylinders 154 and 156 may be replaced with pneumatic or other equivalently functioning devices.

With reference to FIGS. 1, 2, and 6, the farm implement 100 further comprises a plurality of tires 160 rotatably coupled to the frame 104. As shown in FIG. 1, tire-pivoting flanges 162 extend from the lower surface of the central frame structure 108. A tire-pivoting shaft 164 is pivotally received in apertures in the flanges 162. Tire-supporting arms 166 are fixedly attached, such as by welding, to the tire-pivoting shaft 164. Each of the tire-supporting arms 166 supports a respective spindle 168 rotatably carrying one or more of the tires 160. The tires 160 are longitudinally offset with respect to each other, as best shown in FIG. 6. This arrangement is designed for stabilization to minimize bouncing of the implement 100 on a highway or seedbed for achieving consistent and uniform depth control of a seedbed.

Hydraulic cylinders 170 are pivotally coupled to the frame 104 and respective tire-supporting arms 166. Pressurization of the cylinders 170 pushes on the tire-supporting arms 166, thereby pivoting the tires 160 into a lower, deployed position. On the other hand, depressurizing the cylinders 170 pivots the wheel-pivoting shaft 164 in the opposite direction to raise the tires 160. As is apparent, fully lowering of the tires 160 allows for movement of the implement 100 on a road, while raising of the tires 160 from its fully lowered state allows for adjustments to the depth of the resulting seedbed.

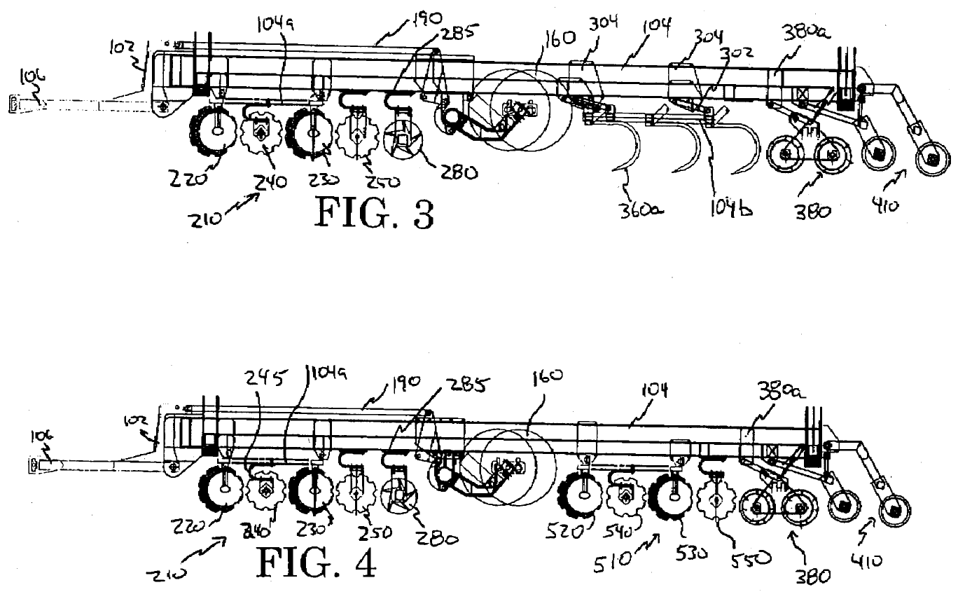

The implement 100 may also be equipped with a depth-adjusting and leveling assembly 190 (FIGS. 3 and 4) for adjusting the front or rear depth at which the implement 100 enters the soil. Examples of depth-adjusting and leveling assemblies, as well as alternative designs for raising and lowering the wheels 160, are disclosed in U.S. Pat. No. 5,622,227 and Ser. No. 10/126,433, the disclosures of which are incorporated herein by reference.

Supported by the frame 104 are a plurality of secondary frames 104a and a plurality of multi-disc units 210 arranged in side-by-side relationship. In a more preferred embodiment, first, second, and third multi-disc units are arranged in side-by-side relationship (across the width of the frame 104) under the first frame wing 130, the central frame structure 108, and the second frame wing 132, respectively. Each of the multi-disc units 210 is coupled to a respective secondary frame 104a, which in turn couples the multi-disc units to frame 104. Alternatively, the multi-disc units 210 may comprise a continuous unit extending across all or substantially all of the width of the frame 104.

With particular reference to FIGS. 1, 2, and 12, each of the multi-disc unit 210 comprises a plurality of rotatable first discs 220, a plurality of rotatable second discs 230, a first flow controller assembly 240, and a second flow controller assembly 250.

The first discs 220 are coupled to the secondary frame 104a of frame 104 and arranged in a first row, which as illustrated is preferably substantially perpendicular to the direction of travel. The second discs 230 are also coupled to the secondary frame 104a of frame 104 and are arranged in a second row, which is behind the row of first discs 220 and is also substantially perpendicular to the direction of travel. Preferably, the first row and second row of discs 220 and 230 are each linear, with the second row of discs 230 set behind and parallel to the first row of discs 220. As shown in FIG. 12, each of the first discs 220 is individually coupled to and suspended from the secondary frame 104a by a respective first arm 222. Likewise, each of the second discs 230 is individually coupled to and suspended from the secondary frame 104a by a respective second arm 232. The first and second discs 220 and 230 are coupled concentrically and rotatably to their respective arms 222 and 232 to allow rotational movement of the discs 220 and 230 during movement of the discs 220 and 230 across the ground along the direction of travel. Suitable discs 220 and 230 and bearing structures are available through Wishek Steel and Manufacturing.

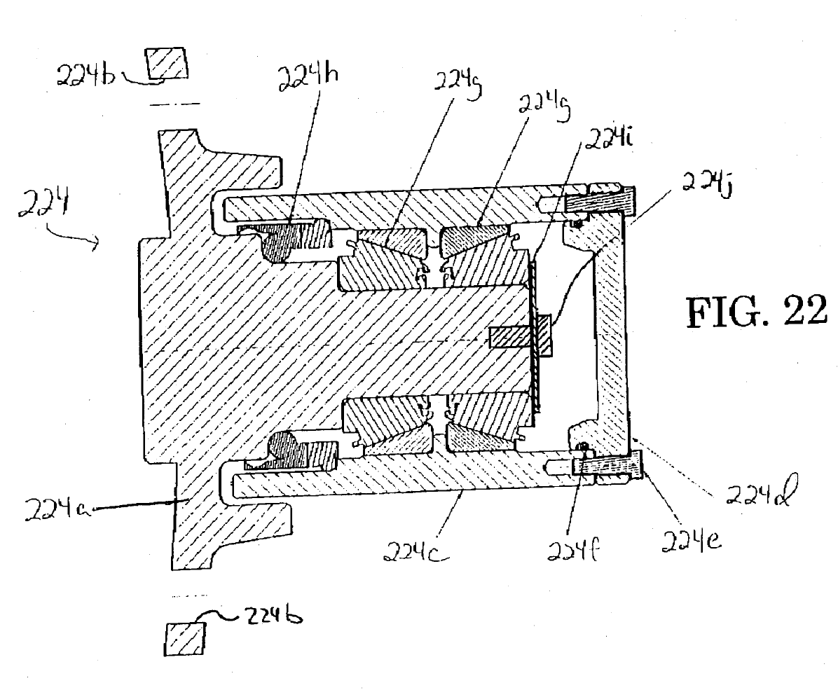

A suitable bearing arrangement 224 that may be used for rotatably connecting the first and second discs 220 and 230 to the first and second arms 220 and 230, respectively, is shown in FIG. 22. The bearing arrangement 224 includes a spindle 224a having bolt holes 224b. Bolts (not shown) may be inserted through the bolt holes 224b to attach the spindle 224a to a corresponding one of the discs 220 or 230. The spindle 224a is mated with housing 224c, which in turn may be welded or otherwise fastened to a corresponding arm 222 or 232. A cap 224d is positioned at an opposite end of the housing 224c, and fastener pins 224e fasten the cap 224d to the housing 224c. O-ring 224f seals the interface between the housing 224c and the cap 224d. A bearing set 224g is positioned inside of the housing 224c to rotatably connect the housing 224c to the spindle 224a. Timkin JLM506849 and JLM 506810 may be selected for the bearing set 224g. A mechanical seal 224h is positioned inside of the housing 224c to prevent debris from entering into the housing 224c and interfering with the operation of the bearing set 224g. Washer 224i and bolt 224j hold the bearing set 224g on the spindle 224a. The illustrated bearing arrangement is presented by way of example, and is not to be considered exhaustive as to the scope of this invention.

Each of the first and second discs 220 and 230 has a respective ground-engaging outer periphery, which in the illustrated embodiment comprises notches, in particular semi-circular notches. For each disc 220 and 230, the notches extend substantially radially into the disc, and are spaced circumferentially relative to each other. It should be understood, however, that the notches on the first and second discs 220 and 230 are optional. It is also possible to use notches on the some of the discs, but not others. In this regard, it is within the scope of this invention for the peripheries of the discs 220 and 230 to have notches and/or protrusions of various shapes, sizes, and patterns.

As is also shown in the illustrated embodiment, the first discs 220 and second discs 230 preferably, but not necessarily, have respective concave faces partially exposed to the direction of travel of the farm implement 100. In a particularly preferred embodiment, the first and second discs 220 and 230 are 56 cm (22 inches) to 81 cm (32 inches), more preferably 71 cm (28 inches) in diameter. Preferred sizes of the discs may depend upon the intended use of the implement 100 and the intended use of the field to be tilled, among other factors. The first discs 220 are spaced apart from each other axially by, for example and not necessarily limitation, about 25 cm to about 35.6 cm (10 to 14 inches). Likewise, the second discs 230 may be spaced apart from one another by the same (or different) axial spacing.

As shown in FIGS. 1, 2, and 12, the outer peripheries of the first discs 220 define respective first planes angled acutely relative to the direction of travel. Likewise, the outer peripheries of the second discs 230 define respective second planes angled acutely relative to the direction of travel. The first planes are angled to an opposite side of the direction of travel than the second planes, so that the concave surfaces of the first discs 220 face in a substantially opposite direction to the concave surfaces of the second discs 230. The first planes and second planes are preferably angled relative to (and on opposite sides of) the direction of travel, i.e., the longitudinal axis of the implement 100 in the illustrated embodiment, by 10 degrees to 25 degrees, more preferably about 17 degrees to about 18 degrees. In the modified embodiment depicted in FIG. 12, the multi-disc unit comprises adjusters 228 and 238 connected to each of the arms 222 and 232, respectively. Lateral movement of the adjusters 228 and 238 alters the angle of the first and second discs 220 and 230, respectively, in unison relative to the direction of travel.

In the illustrated embodiment, the multi-disc unit 210 has a first flow controller assembly 240 for knocking down ground tilled by the first discs for tillage by the second discs. The first flow controller assembly 240 is coupled to the frame 104 and positioned between the plurality of first discs 220 and the plurality of second discs 230 relative to the direction of travel. The second flow controller assembly 250 is coupled to the frame 104 and positioned behind the plurality of second discs 230 relative to the direction of travel. The second flow controller assembly 250 knocks down ground tilled by the second discs. The fragmented view of FIG. 12 depicts the first flow controller assembly 240, but not the second flow controller assembly 250.

In a preferred embodiments of the invention illustrated in FIGS. 1 and 2, the first flow controller assembly 240 comprises a coulter shaft 242 and a plurality of coulter blades (or discs) 244 annular in shape to snugly fit over the coulter shaft 242. The coulter blades 244 are spaced apart axially relative to each other along the axis of the coulter shaft 242. Each of the coulter blades 244 has a ground-engaging outer periphery. The coulter blades 244 are rotatable as the blades 244 move across and contact the ground along the direction of travel. Rotation of the coulter blades 244 may be accomplished by rotatably connecting the coulter shaft 242 about its supports (described below). Alternatively, the coulter shaft 242 may be stationary (non-rotatable), so that the coulter blades 244 are rotabably connected to the stationary coulter shaft 242.

Preferably the outer peripheries of the coulter blades 244 define respective third planes parallel to the direction of travel. Optionally, each of the coulter blades 244 may have an outer periphery extending between a corresponding set of adjacent first discs 220 located generally forward of the coulter blade 244 and between a corresponding set of adjacent second discs 230 located generally rearward of the coulter blade 244. The peripheries of the coulter blades 244 may have notches extending radially inward, as is known in the art and shown in the embodiments of FIGS. 3-5. The coulter blades 244 may also be fluted. In one preferred embodiment, the coulter blades are 46 cm (18 inches) to 66 cm (26 inches) in diameter, more preferably 61 cm (24 inches) in diameter.

The function of the coulter blades 244 of the first flow controller assembly 240 will now be described in further detail. During operation, the first discs 220 preferably pick up and throw tilled ground along a generally traverse direction, and optionally rearward. Depending upon the speed at which the farm implement 100 is moved across the ground, the first discs 220 may throw a portion of the tilled ground over or through the row of second discs 230, thus inhibiting the operation of the second discs 230. The coulter blades 244 preferably function to ensure that the ground tilled by the first discs 220 is knocked down ground before it reaches the second discs 230, so that the second discs 230 may receive and treat the ground. In this regard, the coulter blades 244 may impede lateral and/or longitudinal movement of the ground tilled by the first discs 220.

One benefit of the first flow controller assembly 240 of this embodiment is that proper function of the flow controller assembly 240 is not dependent upon an accelerator for increasing the rotational speed of the coulter blades 244 relative to the first and second discs 220 and 230. Rather, the rotational speed of the coulter blades 244 may be controlled by the ground-engaging motion of the outer peripheries of the coulter blades 244. In this embodiment, the rotational speed imparted by contact of the coulter blades 244 and the ground is sufficient for knocking down ground tilled by the first discs 220, thus allowing the second discs 230 to treat the ground tilled by the first discs 220. (It is to be understood, however, that the use of an accelerator for increasing the rotational speed of the first discs 220, the second discs 230, or the first flow controller assembly 240 is not outside the scope of this invention.)

In a preferred and the illustrated embodiments of the invention, the second flow controller assembly 250 comprises a coulter shaft 252 and a plurality of coulter blades 254, as described above with reference to the first flow controller assembly 240. In the interest of brevity, the above description of the coulter shaft and coulter blades is incorporated, but will not be repeated here.

Preferably the outer peripheries of the coulter blades 254 of the second flow controller assembly 250 define respective fourth planes parallel to the direction of travel. Optionally, each of the coulter blades 254 of the second flow controller assembly 250 may have an outer periphery extending between a corresponding set of adjacent second discs 230 located generally forward of the coulter blades 254.

The function of the coulter blades 254 of the second flow controller assembly 250 will now be described in further detail. During operation, the second discs 230 preferably pick up and throw tilled ground in a generally traverse direction to the direction of movement, and optionally rearward. Depending upon the speed at which the farm implement 100 is moved across the ground, the second discs 230 may throw a portion of the tilled ground over or through the cultivating device immediately following the multi-disc unit 210. The coulter blades 254 of the second flow controller assembly 250 preferably function to ensure that the ground tilled by the second discs 230 is knocked down ground before it reaches the cultivating devices following the multi-disc unit 210. In this regard, the coulter blades 254 of the second flow controller assembly 250 may impede lateral and/or longitudinal movement of the ground tilled by the first discs 220.

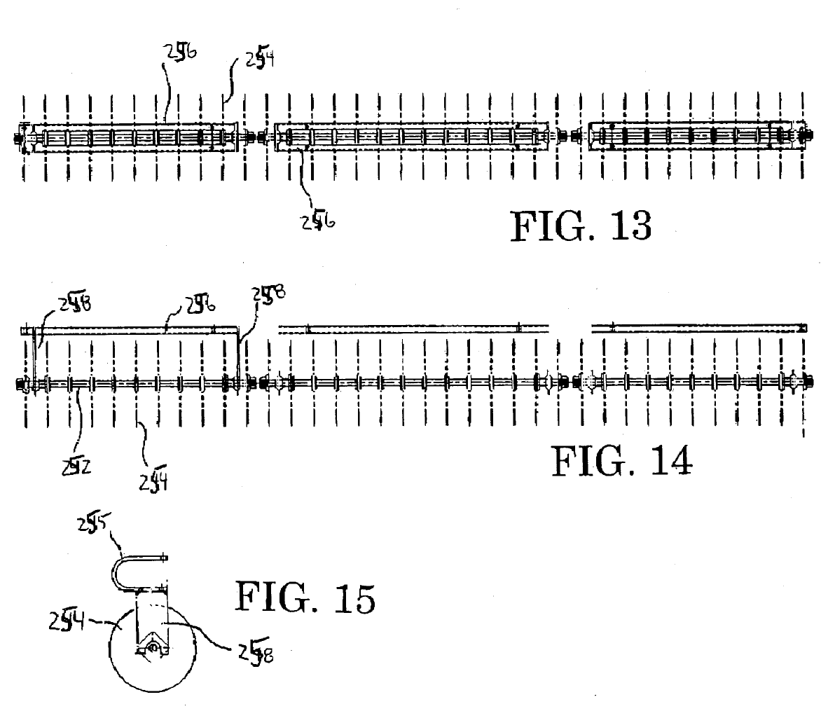

In the embodiment depicted in FIGS. 1, 2, and 13-15, the ends of the coulter shaft 252 are rotationally coupled to coulter side weldments 258 by an appropriate bearing arrangement or the like. A coulter cross member 256 extends between the coulter side weldments 258 to maintain the spacing between the side weldments 258 and provide structural support to the coulter assembly 250. A U-shaped resilient spring 255 suspends the first controller assembly 240 from the frame 104. Referring more particularly to FIG. 15, one end of the spring 255 includes a first aperture for fastening (e.g., with a bolt or screw) the frame 104. The other end of the spring 255 contains a second aperture for fastening (e.g., with a bolt or screw) the spring 255 to the coulter cross member 256. The spring 255 essentially provides the coulter assembly 250 with a floating arrangement. The first flow controller assembly 240 may be suspended from the secondary frame 104a in a similar manner, i.e., with the use of spring 245, although a cross member equivalent to 256 is preferably not used for suspending the first flow controller assembly 240.

It is to be understood that the U-shaped resilient springs 245 and 255 are optional means for fastening the first and second flow controller assemblies 240 and 250 to the frame. Other fasteners or structures may also be used. For example, according to one modification depicted in the embodiment shown in FIG. 12, rigid arms 245a couple the coulter shaft 242 and the frame 104 to one another.

It should be understood that the multi-disc units 210 may possess additional or alternative cultivating devices to those illustrated and described above. By way of example and not necessarily limitation, the first and/or second flow controller assemblies 240 and 250 may be replaced with a middle reel (similar to reel assembly 280, described below), ring rollers, disc blades, a rotating shaft with radially extending paddles, or a rotary hoe, in any combination. Implementation of such modifications to the multi-disc unit 210 would be within the purview of persons having ordinary skill in the art and reference to this disclosure.

With reference to FIGS. 1 and 2, the next device coupled to the frame 104 is an additional coulter blade assembly 260. The components, structure, construction, and operation of coulter blade assembly are discussed above and, in the interest of brevity, incorporated but not repeated here. The coulter blade assembly 260 may be divided into three sections arranged in side-by-side relationship under the first frame wing 130, the central frame structure 108, and the second frame wing 132, respectively. A U-shaped resilient spring 265 may be used to suspend the coulter blade assembly 260 from the frame 104.

It should be understood that the coulter blade assembly 260 may be supplemented with additional devices or replaced by alternative devices to those illustrated and described above. By way of example and not necessarily limitation, the coulter blade assembly 260 may be replaced by other devices, including, not necessarily by limitation, a mid-reel assembly, ring rollers, disc blades, a rotating shaft with radially extending paddles, and/or a rotary hoe, in any combination.

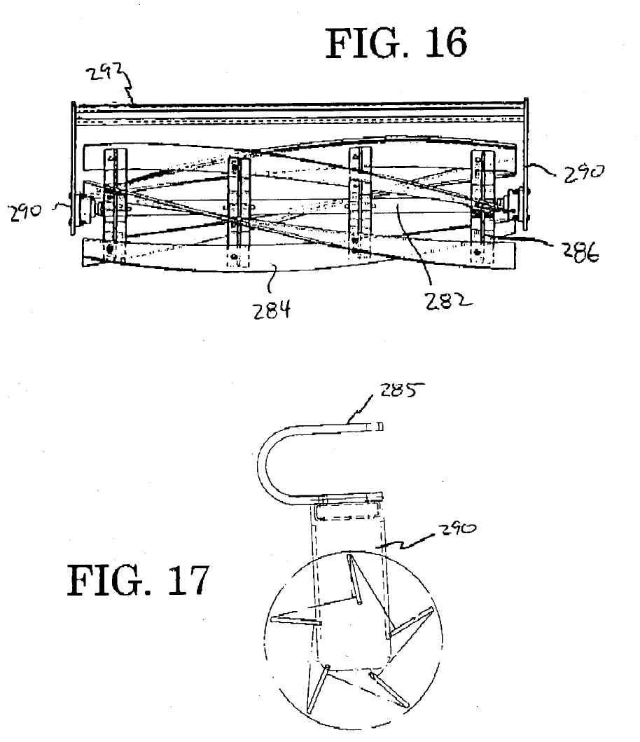

FIGS. 3 and 4 depict embodiments in which the coulter blade assembly 260 has been replaced by a mid-reel assembly 280. The reel assembly 280 is preferably of the type commercially available under the name “DO-ALL” manufactured by Forrest City Machine Works, Inc. of Forrest City, Ark. Referring to FIGS. 16 and 17, the reel assembly 280 comprises a reel shaft 282 and blades 284 attached to the outer peripheral surface of the reel shaft 282 via attaching members 286. The attaching members 286 are preferably welded to a peripheral surface of the reel shaft 282 and the blades 284 are preferably bolted to the attaching members 286. The blades 284 have radial-outer ground-engaging edges. The blades 284 are preferably pitched or angled with respect to the longitudinal axis of the reel shaft 282 to provide the blades 284 with a substantially helical pattern. For example and not necessarily by limitation, for a shaft 282 having a width of 1.8 meters (70 inches) and diameter of 56 cm (22 inches), five of the blades 284 may be used, and each of the blades 284 may twist extend around the periphery of the shaft 282 by 108 degrees.

The working of the soil by the multi-disc units 210 allows the reel assembly 280 to operate at maximum performance to chop stubble or other debris and to break clods while mixing the loosened soil. The reel assembly 280 rotates as the implement 100 is pulled through the soil such that the edges of the blades 284 perform the chopping and breaking function. To enhance this function, the blades 284 may be radially offset (or slanted) forward by, for example and not necessarily limitation, an angle of 10 to 12 degrees. In a particularly preferred yet optional embodiment, the blades 344 are 8 cm (3 inches) to 15 cm (6 inches) in wide, more preferably 10 cm (4 inches) wide, and 0.64 cm (1/4 inch) to 1.3 cm (1/2 inch), more preferably 0.95 cm (3/8 inch) in thickness.

The ends of the reel shaft 282 are rotationally coupled to mid-reel side weldments 290 by an appropriate bearing arrangement or the like. A mid-reel cross member 292 extends between the mid-reel side weldments 290 to maintain the spacing between the side weldments 290 and provide structural support to the mid-reel assembly 280. A U-shaped resilient spring 285 (FIGS. 3 and 17) suspends the mid-reel assembly 280 from the frame 104. Referring more particularly to FIG. 17, one end of the spring 285 includes a first aperture for fastening (e.g., with a bolt or screw) the spring 285 to the frame 104. The other end of the spring 285 contains a second aperture for fastening (e.g., with a bolt or screw) the spring 285 to the mid-reel cross member 292. The spring 285 essentially provides the mid-reel assembly 280 with a floating arrangement, allowing the assembly 280 to move upward and downward with the contour of the ground.

With reference to FIGS. 1, 2, 18, and 19, chisel shanks 360 (or tines) are positioned rearward of the coulter blade assembly 260. Each row of shanks 360 is offset in the lateral direction from its adjacent row or rows of shanks 360. Each shank 360 in each row is spaced from adjacent shank. As referred to herein, chisel shanks 360 also mean blades capable of penetrating into the earth, including those having a sweep or tooth (not shown) disposed on its lower end to engage the ground.

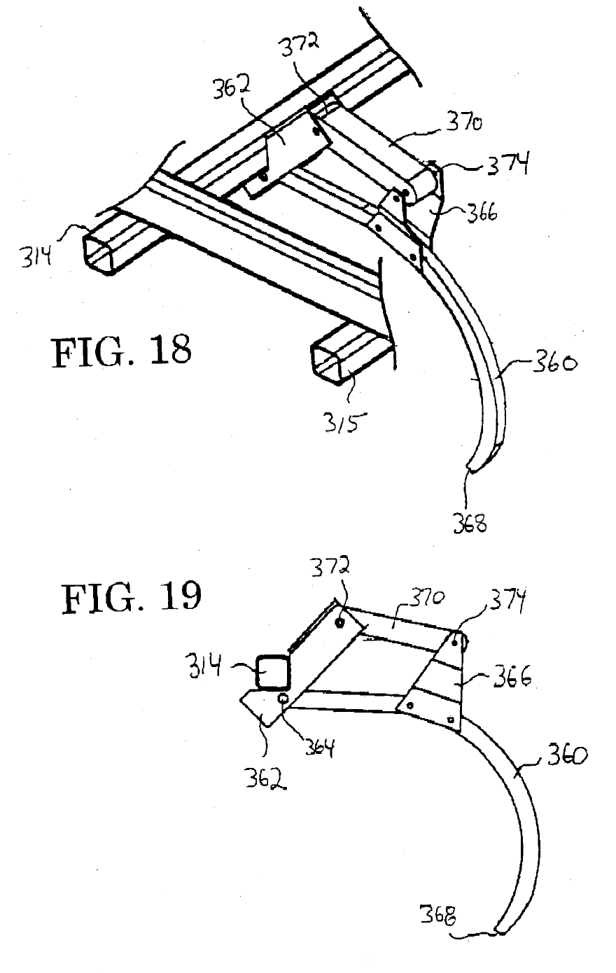

The shanks 360 are attached to a secondary frame 104b located below the frame 104. More specifically, and with reference to FIG. 1, pistons 302 suspend the secondary frame 104b from a plurality of brackets 304 coupled to the frame 104. The secondary frame 100 comprises crossbeam rows 314, 315, 316, and 317 for suspending the chisel shanks 360 as follows. Referring to the shank 360 illustrated in FIGS. 18 and 19, a base 362 having an indentation 364 is attached to crossbeam 314 by welding, bolts, or the like. In the illustrated embodiment, the base 362 is arranged at a 45 degree angle relative to the crossbeam 314. A first end of the shank 360 is connected pivotally to the bottom of the base 362 at pin 364. The shank 360 passes through a coupler 366, then curves downward towards the ground before terminating in a second end 368, which may be blunt or pointed (see FIG. 3, reference numeral 360a), depending upon design choice. One end of a linkage 370 (which optionally may comprise a hydraulic piston) is attached to the upper end of the base 362 at joint 372. The other end of the linkage 370 is attached to the coupler 366 at joint 374. The illustrated chisel shank is commercially available from John Deere and from Belota under Part Numbers 12464 and 12467. Other variations of shanks and other penetrating members, such as the S-shaped tines disclosed in U.S. Pat. No. 5,622,227, may be used herein in place of the chisel shanks. For this reason, the chisel shanks are preferably detachable and reattachable to the frame 104. It is also possible to use a combination of different types of shanks and/or tines, for example, blunted and pointed chisel shanks.

With reference to FIGS. 1, 2, 20, and 21, basket units 380 will be described. Three basket units 380 are positioned across the rear of the implement 100, with the basket units 380 coupled in side-by-side relationship to the first frame wing 130, the central frame structure 108, and the second frame wing 132, respectively. Each basket unit 380 comprises a top horizontal beam 384 having a connecting flange 389. A basket unit load-adjusting actuator 385 (FIG. 1) couples the connecting flange 389 to the frame 104.

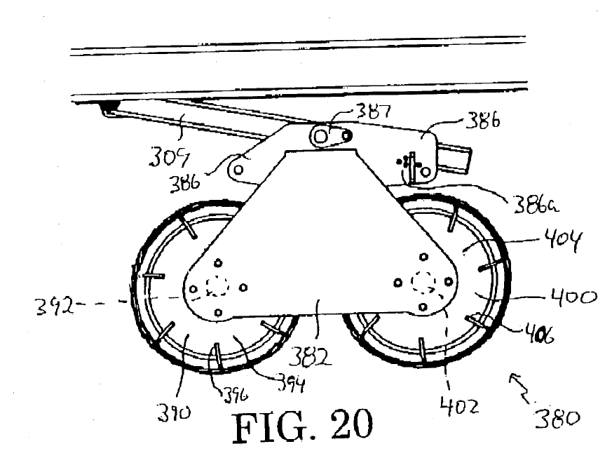

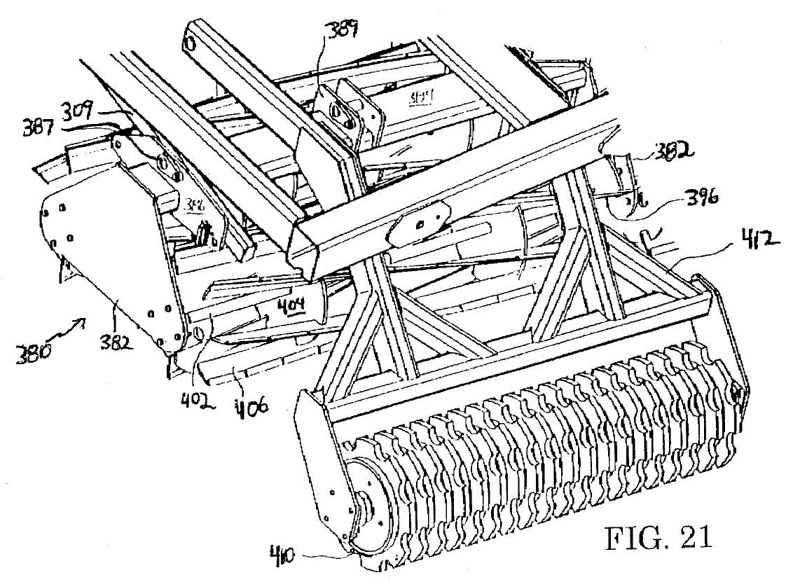

At opposite ends of the top horizontal beam 384 are end panels 382, which have a generally triangular, yet truncated appearance, as shown in FIGS. 20 and 21. Mounted on the top horizontal beam 384 is a tilt-adjustment member 386, which has an aperture through which the top horizontal beam 384 is received. A pivot-pin arrangement 387 is used to pivotally connect the tilt-adjustment member 386 to a suspension beam 309, which forms part of the frame wing 130. The rear end of the tilt-adjustment member has a plurality of apertures generally designated by reference numeral 386a. (These apertures may alternatively be placed at the front end of the tilt-adjustment member 386.) The apertures 386a are each capable of being aligned with a rear aperture (not shown) of the suspension beam 309. A different tilt position is associated with each of the apertures 386a. Once a desired tilt angle has been selected, a lock pin may be placed through the selected aperture 386a and aperture (not shown) of the suspension beam 309.

Each basket unit 380 has a forward roller 390 with a shaft 392 and a rearward roller 400 with a shaft 402. The shafts 392 and 402 are rotatably supported between the end panels 382. Any suitable bearing arrangement may be used to support the shafts 392 and 402 on the panels 382. The shafts 392 and 402 have circular attaching members 394 and 404 disposed at locations along their peripheral surfaces. The attaching members 394 and 404 are used to support blades 396 and 406. The attaching members 394 and 404 are preferably attached to the shafts 392 and 402 by welding and the blades 396 and 406 are likewise preferably attached to the members 394 and 404 by welding, although conventional fasteners and other fastening techniques may be used. The blades 396 and 406 are pitched or angled with respect to the longitudinal axis of the shafts 392 and 402 when they are connected to the members 394 and 404. That is, the blades 396 and 406 are twisted about their longitudinal axis when attached to the members 394 and 404 such that the blades 396 and 406 are angled or pitched with respect to the shafts 392 and 402, such as along helical paths. For example, for a shaft 392 or 402 having a width of 1.8 meters (70 inches) and a diameter of 40 cm (16 inches), seven of the blades 396 or 406 may be used. The blades 396 or 406 may twist extend around the periphery of the shaft 392 or 402 by, for example, 60 to 90 degrees, more preferably 77 degrees.

The blades 396 and 406 of the rollers 390 and 400 preferably are angled slightly forwardly toward the direction of rotation of the rollers 390 and 400, for example, by 10 to 12 degrees from radial. In a particularly preferred embodiment, the blades 396 and 406 are 5.1 cm (2 inches) to 10.2 cm (4 inches wide), more preferably 7.6 cm (3 inches) wide, and 0.63 cm (1/4 inch) to 1.3 cm (1/2 inch), more preferably 0.95 cm (3/8 inch) in thickness.

The basket unit load-adjusting actuators 385 (FIG. 1) may be, for example, a hydraulic or pneumatic cylinder or the like. As the load-adjusting actuator 385 is pressurized, the rollers 390 and 400 are lowered towards the soil. As is apparent, the cylinders can be used to apply variable pressure to the soil through the rollers 390 and 400 and to thus obtain the desired soil condition of a seedbed.

In the event that the cylinder-piston devices described above are hydraulic cylinders, the cylinders can be hooked up to the hydraulic system of the tractor and can thus be adjusted by the machine operator even when the implement is being pulled through the soil. By individually controlling the respective loads of the various components of the implement 100, the operator can distribute weight evenly throughout the cultivating devices of the implement 100 to minimize compaction and attain desired tillage effects.

As described above, each basket unit 380 can have a tilt adjusting capability. To adjust the tilt of the basket unit 380, the pivot-pin arrangement 387 is unlocked and the basket unit 380 is tilted to its desired position to align the aperture (not shown) of the suspension beam 309 with a corresponding one of the apertures 386a. The pivot-pin arrangement 387 is then locked, and a lock pin is placed through the appropriate aperture 386a and the suspension beam aperture. Adjusting the tilt of the basket units 380 allows the implement operator to adjust the flow of soil through the basket units 380. For example, tilting the basket units 380 forward causes the front roller 390 to carry (accumulate) soil, which may be pushed into holes in the seed bed. Forward tilting of the basket units 380 also effectively cuts through and moves high spots in the seedbed, further promoting a level seedbed.

With reference to FIGS. 1-4 and 21, finishing rollers 410 can be located behind the rear roller 400 of the basket unit 380. Support frames 412 rotatably supports the finishing rollers 410. Each of the support frames 402 extends from and is connected to the rearwardmost of beams of the frame 104. The finishing rollers 410 may be solid rollers, spiral rollers, and/or floating rings, optionally having notches disposed circumferentially along its peripheral surface and extending radially inward. The finishing rollers 410 serve to further break down any remaining dirt clods and serves to seal moisture into the ground.

The farm implement 100 may comprise additional mechanisms. By way of example, the farm implement may be equipped with a double disc opener with a depth control and/or firming wheel for planting seeds. The double disc opener may be positioned at any of various positions along the implement, but according to one preferred embodiment is located behind the basket unit.

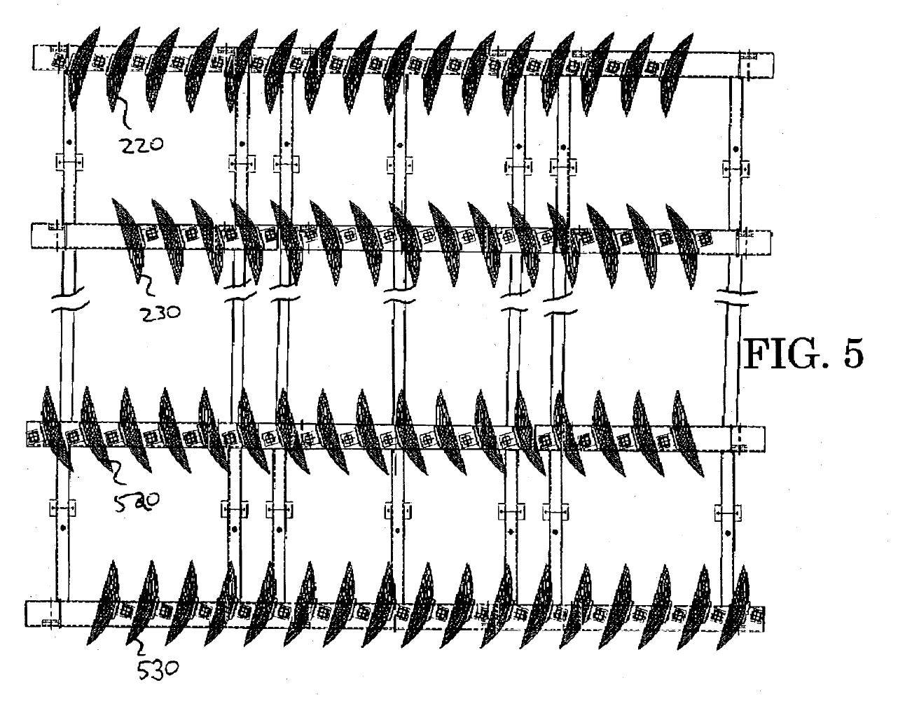

An embodiment comprising a modification to the farm implement of FIGS. 1 and 2 is illustrated in FIGS. 4 and 5. In this modified embodiment, the chisel shanks 360 have been replaced with a second multi-disc unit 500.

According to this embodiment, the farm implement comprises a frame 104, a forward multi-disc unit 210 coupled to the frame 104, and a rearward multi-disc unit 510 coupled to the frame 104 behind the forward multi-disc unit 210 along the direction of travel. The forward multi-disc unit 210 comprises a plurality of rotatable first discs 220 having respective first ground-engaging outer peripheries for engaging and tilling the ground, and a plurality of rotatable second discs arranged behind the first discs along the direction of travel. Each of the first ground-engaging outer periphery defining a respective first plane angled acutely to the direction of travel, preferably for directing the tilled ground in a second generally transverse direction relative to the direction of travel. The second discs 230 have respective second ground-engaging outer peripheries for engaging and tilling the ground tilled by the plurality of rotatable first discs. Each of the second ground-engaging outer periphery defining a respective second plane angled acutely to an opposite side of the direction of travel than the first planes, preferably for directing the tilled ground in a second generally transverse direction relative to the direction of travel. The forward multi-disc unit 210 further comprises a first flow controller assembly 240 situated between the plurality of first discs 220 and the plurality of second discs 230 for knocking down ground tilled by the first discs for tillage by the second discs. The forward multi-disc unit 210 still further comprises a second flow controller assembly 250 situated behind the plurality of second discs for knocking down ground tilled by the second discs. The first and second flow controller assemblies 240 and 250 may be the same or different from one another, and may comprise, for example and not necessarily limitation, coulter assemblies and/or mid-reel assemblies.

The rearward multi-disc unit 510 of this embodiment is coupled to the frame 104 (via secondary frame 104b) and thus arranged behind the forward multi-disc unit 210 along the direction of travel. The rearward multi-disc unit 510 comprises a plurality of rotatable third discs 520, a plurality of rotatable fourth discs 530, a third flow controller assembly 540 and a fourth flow controller assembly 550. The third discs 520 have respective third ground-engaging outer peripheries for engaging and tilling the ground. Each of the third ground-engaging outer peripheries defines a respective third plane angled acutely relative to the direction of travel (and preferably to an opposite side of the direction of travel than the second planes), preferably for directing the tilled ground in a third generally transverse direction relative to the direction of travel. The fourth discs 530 are arranged behind the third discs 520 along the direction of travel and have respective fourth ground-engaging outer peripheries for engaging and tilling the ground tilled by the plurality of rotatable third discs 520. Each of the fourth ground-engaging outer periphery define a respective fourth plane angled acutely to an opposite side of the direction of travel than the third planes for directing the tilled ground in a fourth generally transverse direction relative to the direction of travel. The third flow controller assembly 540 is situated between the plurality of third discs 520 and the plurality of fourth discs 530 for knocking down ground tilled by the third discs 520 for tillage by the fourth discs 530. The fourth flow controller assembly 550 is situated behind the plurality of fourth discs 530 for knocking down ground tilled by the fourth discs 530. The third and fourth flow controller assemblies 540 and 550 may be the same or different from one another, and may comprise, for example and not necessarily limitation, coulter assemblies and/or mid-reel assemblies.

One possible mode of operation of the implement 100 will be described. It is to be understood, however, that the mode of operation described below is not exhaustive of the scope of this invention. Many variations and modifications fall within the scope of the invention.

The implement 100 is first connected to a tractor or other pulling mechanism by the hitch portion 102 and the appropriate hydraulic hookups are made to the tractor. The implement is then lowered into the soil using the cylinders 170 as described above. The depth to which the implement engages the soil can be adjusted by 190. As the implement is pulled through the soil, the multi-disc unit 210 is the first device on the implement to engage compacted soil. The unit 210 serves to break and loosen the compacted soil as follows. During movement of the farm implement 100 across the ground along the direction of travel, the row of first discs 220 penetrates and inverts the soil, while also displacing the soil in a first generally lateral direction. The first flow controller assembly 240 controls soil flow by having the coulter blades 244 knock down and redirect soil along a substantially longitudinal path. The coulter blades 244 thereby impede excess lateral and upward/rearward movement of the soil inverted and displaced by the row of first discs 220. The second row of discs 230 then inverts the soil again and returns the soil toward its original lateral location. Next, the second flow controller 250 controls soil flow by knocking down and redirecting soil along a substantially longitudinal path, impeding excess lateral and upward/rearward movement of the soil inverted and displaced by the row of second discs 230.

After compacted soil has been loosened and broken by unit 210, the coulter assembly 260 penetrates deeper into the ground with its sharp edges and breaks up large clumps of soil loosened by unit 210. Alternatively, a reel assembly 280 or other cultivating device may be substituted for chopping debris and breaking soil clods.

The rows of chisel shanks 360 then penetrate deeper into the loosened soil to blend and mix the soil, leaving furrows and bringing clods and stubble to the surface. Further, because the soil has been conditioned by the multi-disc unit 210, and the coulter assembly 260 or the reel assembly 280, the rows of the chisel shanks 360 are allowed to operate at maximum performance to further mix and incorporate debris into the seedbed. The arrangement of the rows of chisel shanks or tines 360 ensures that the soil passed over by the implement is adequately mixed and conditioned by the chisel shanks or tines 360.

The additional soil loosened by the chisel shanks 360 serves to load front basket unit 380. The front rollers 390 serve to mix, blend and condition the seedbed, while propelling dirt upwardly and rearwardly to load the rear rollers 400 to thus maximize the performance of the rear rollers 390. The rear rollers 400 serve to further blend and mix the soil and to ensure that any debris is incorporated into the seedbed. Further, the load-adjusting actuator and the tilt adjustment arrangement can adjust the force with which the rollers 390 and 400 engage the soil to form a loose or firm seedbed.

The finishing roller 410 is the last device on the implement and serves to break down any remaining clods, smooth the soil, and seal in moisture.

Thus, the farm implement 100 in a single pass takes compacted soil and transforms it into a smooth seedbed of consistent depth without waves or ruts. More particularly, because a single frame 104 supports the cultivating devices described above, the seedbed will have a consistent depth. The various load-adjustment actuators may be used to facilitate this object by causing the cultivating devices to apply variable forces to the ground. This arrangement allows for enhanced performance in preparing seedbeds having depths, for example, of 10.2 cm (4 inches) to 31 cm (12 inches). Thus, the problems associated with multiple passes with multiple different implements resulting in inconsistent depth and conditions of a seedbed may be eliminated.

Placement of the cultivating devices in the order described above is believed to optimize the operation of the devices. However, it is within the scope of this invention to change the order of the cultivating devices from that shown, to add additional cultivating devices to the frame, and/or to omit one or more of the cultivating devices shown. Also, it should be understood that the folding feature of the illustrated farm implement 100 is optional. The pivotal connections of the frame wings 144 to the central frame structure 108 may be substituted with more conventional welding or fasteners. In this regard, instead of segmenting the cultivating devices (e.g., multi-disc unit 210, coulter assembly 260, reel assembly 280, and rear basket unit 380) as illustrated for facilitating folding, these and other cultivating devices may extend across most or all of the width of the implement 104.

The various examples of dimensions given above are by way of illustration, and are not exhaustive of the scope of the invention. Varying dimensions to fit the intended us of the implement 100 is well within the purview of those having ordinary skill in the art.

The foregoing detailed description of the preferred embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A farm implement movable across ground along a direction of travel for tillage of the ground, the farm implement comprising:
a frame; and
a multi-disc unit coupled to the frame, comprising
a plurality of rotatable first discs having respective first ground-engaging outer peripheries for engaging and tilling the ground, each of the first ground-engaging outer peripheries defining a respective first plane angled acutely relative to the direction of travel;
a plurality of rotatable second discs arranged behind the first discs along the direction of travel having respective second ground-engaging outer peripheries for engaging and tilling the ground tilled by the plurality of rotatable first discs, each of the second ground-engaging outer periphery defining a respective second plane angled acutely to an opposite side of the direction of travel than the first planes;
a first flow controller assembly situated between the plurality of first discs and the plurality of second discs for knocking down ground tilled by the first discs for tillage by the second discs; and
a second flow controller assembly situated behind the plurality of second discs for knocking down ground tilled by the second discs.

2. The farm implement of claim 1, wherein:
the ground-engaging outer peripheries of the first discs each comprise notches extending substantially radially inward relative to the first discs and spaced circumferentially relative to each other; and
the ground-engaging peripheries of the second discs each comprise notches extending substantially radially inward relative to the second discs and spaced circumferentially relative to each other.

3. The farm implement of claim 1, wherein the first discs are arranged in a first row substantially perpendicular to the direction of travel and the second discs are arranged in a second row substantially perpendicular to the direction of travel.

4. The farm implement of claim 1, wherein the first planes and the second planes are offset relative to the direction of travel by 10 degrees to 25 degrees.

5. The farm implement of claim 1, wherein the first planes and second planes are offset relative to the direction of travel by 17 to 18 degrees.

6. The farm implement of claim 1, wherein each of the first discs and each of the second discs have a respective concave face exposed to the direction of travel.

7. The farm implement of claim 1, wherein the first flow controller assembly chops and breaks the ground tilled by the first discs.

8. The farm implement of claim 1, wherein the second flow controller assembly chops and breaks the ground tilled by the second discs.

9. The farm implement of claim 1, wherein at least one of the first and second flow controller assemblies comprises a coulter shaft and a plurality of rotatable coulter blades spaced apart axially relative to each other along the axis of the coulter shaft, each of the coulter blades having a ground-engaging outer periphery.

10. The farm implement of claim 9, wherein the outer peripheries of the coulter blades define respective third planes parallel to the direction of travel.

11. The farm implement of claim 9, wherein a member selected from the group consisting of the first and second flow controller assemblies comprises a reel assembly, the reel assembly comprising a rotatable reel shaft and a plurality of elongated blades, the reel shaft having a periphery, the longitudinal blades being spaced circumferentially about the periphery of the reel shaft along a helical pattern and having a ground-engaging edge for chopping debris and breaking soil clods.

12. The farm implement of claim 1, wherein at least one of the first and second flow controller assemblies comprises a reel assembly, the reel assembly comprising a rotatable reel shaft and a plurality of elongated blades, the reel shaft having a periphery, the longitudinal blades being spaced circumferentially about the periphery of the reel shaft along a helical pattern and having a ground-engaging edge for chopping debris and breaking soil clods.

13. The farm implement of claim 1, wherein the frame has a front end in the direction of travel, and further wherein the first discs are mounted at the front end.

14. The farm implement of claim 1, further comprising a coulter assembly coupled to the frame and situated immediately behind the second flow controller assembly, the coulter assembly comprising a coulter shaft and a plurality of rotatable coulter blades spaced apart axially relative to each other along the axis of the coulter shaft, each of the coulter blades having a ground-engaging outer periphery.

15. The farm implement of claim 1, further comprising a reel assembly coupled to the frame and situated immediately behind the second flow controller assembly, the reel assembly comprising a rotatable reel shaft and a plurality of elongated blades, the reel shaft having a periphery the longitudinal blades being spaced circumferentially about the periphery of the reel shaft along a helical pattern and having a ground-engaging edge for chopping debris and breaking soil clods.

16. The farm implement of claim 1, further comprising a plurality of rows of at least one member selected from the group consisting of chisel shanks and tines supported by the frame, the rows disposed behind the plurality of second discs along the direction of travel, each of at least one member having an edge portion distal to the frame for engaging the ground.

17. The farm implement of claim 16, wherein said at least one member is detachable from and reattachable to the frame.

18. A farm implement movable across ground along a direction of travel for tillage of the ground, the farm implement comprising:
a frame; and
a forward multi-disc unit coupled to the frame, comprising
a plurality of rotatable first discs having respective first ground-engaging outer peripheries for engaging and tilling the ground, each of the first ground-engaging outer peripheries defining a respective first plane angled acutely relative to the direction of travel;
a plurality of rotatable second discs arranged behind the first discs along the direction of travel having respective second ground-engaging outer peripheries for engaging and tilling the ground tilled by the plurality of rotatable first discs, each of the second ground-engaging outer periphery defining a respective second plane angled acutely to an opposite side of the direction of travel than the first planes;
a first flow controller assembly situated between the plurality of first discs and the plurality of second discs for knocking down ground tilled by the first discs for tillage by the second discs; and
a second flow controller assembly situated behind the plurality of second discs for knocking down ground tilled by the second discs; and
a rearward multi-disc unit coupled to the frame and arranged behind the forward multi-disc unit along the direction of travel, comprising
a plurality of rotatable third discs having respective third ground-engaging outer peripheries for engaging and tilling the ground, each of the third ground-engaging outer peripheries defining a respective third plane angled acutely relative to the direction of travel;
a plurality of rotatable fourth discs arranged behind the third discs along the direction of travel having respective fourth ground-engaging outer peripheries for engaging and tilling the ground tilled by the plurality of rotatable third discs, each of the fourth ground-engaging outer periphery defining a respective fourth plane angled acutely to an opposite side of the direction of travel than the third planes;
a third flow controller assembly situated between the plurality of third discs and the plurality of fourth discs for knocking down ground tilled by the third discs for tillage by the fourth discs; and
a fourth flow controller assembly situated behind the plurality of fourth discs for knocking down ground tilled by the fourth discs.

19. The farm implement of claim 18, wherein:
the ground-engaging outer peripheries of the first discs each comprise notches extending substantially radially inward relative to the first discs and spaced circumferentially relative to each other;
the ground-engaging peripheries of the second discs each comprise notches extending substantially radially inward relative to the second discs and spaced circumferentially relative to each other;
the ground-engaging outer peripheries of the third discs each comprise notches extending substantially radially inward relative to the third discs and spaced circumferentially relative to each other; and
the ground-engaging peripheries of the fourth discs each comprise notches extending substantially radially inward relative to the fourth discs and spaced circumferentially relative to each other.

20. The farm implement of claim 18, wherein the first discs, the second discs, the third discs, and the fourth discs are each arranged in a respective row substantially perpendicular to the direction of travel.

21. The farm implement of claim 18, wherein at least one member selected from the group consisting of the first, second, third, and fourth planes are offset relative to the direction of travel by 10 degrees to 25 degrees.

22. The farm implement of claim 18, wherein at least one member selected from the group consisting of the first, second, third, and fourth planes are offset relative to the direction of travel by 17 to 18 degrees.

23. The farm implement of claim 18, wherein at least one member selected from the group consisting of the first, second, third, and fourth discs have a respective concave face exposed to the direction of travel.

24. The farm implement of claim 18, wherein the first flow controller assembly chops and breaks the ground tilled by the first discs, and the third flow controller assembly chops and breaks the ground tilled by the third discs.

25. The farm implement of claim 18, wherein the second flow controller assembly chops and breaks the ground tilled by the second discs, an the fourth flow controller assembly chops and breaks the ground tilled by the fourth discs.

26. The farm implement of claim 18, wherein at least one of the first, second, third, and fourth flow controller assemblies comprises a coulter shaft and a plurality of rotatable coulter blades spaced apart axially relative to each other along the axis of the coulter shaft, each of the coulter blades having a ground-engaging outer periphery.

27. The farm implement of claim 26, wherein the outer peripheries of the coulter blades define respective planes parallel to the direction of travel.

28. The farm implement of claim 26, wherein at least one of the first, second, third, and fourth flow controller assemblies comprises a reel assembly, the reel assembly comprising a rotatable reel shaft and a plurality of elongated blades, the reel shaft having a periphery, the longitudinal blades being spaced circumferentially about the periphery of the reel shaft along a helical pattern and having a ground-engaging edge for chopping debris and breaking soil clods.

29. The farm implement of claim 18, wherein at least one of the first, second, third, and fourth flow controller assemblies comprises a reel assembly, the reel assembly comprising a rotatable reel shaft and a plurality of elongated blades, the reel shaft having a periphery, the longitudinal blades being spaced circumferentially about the periphery of the reel shaft along a helical pattern and having a ground-engaging edge for chopping debris and breaking soil clods.

30. The farm implement of claim 18, wherein the frame has a front end in the direction of travel, and further wherein the first discs are mounted at the front end.

31. The farm implement of claim 18, further comprising a coulter assembly coupled to the frame and situated immediately behind the second flow controller assembly, the coulter assembly comprising a coulter shaft and a plurality of rotatable coulter blades spaced apart axially relative to each other along the axis of the coulter shaft, each of the coulter blades having a ground-engaging outer periphery.

32. The farm implement of claim 18, further comprising a reel assembly coupled to the frame and situated immediately behind the second flow controller assembly, the reel assembly comprising a rotatable reel shaft and a plurality of elongated blades, the longitudinal blades being spaced circumferentially about the periphery of the reel shaft along a helical pattern and having a ground-engaging edge for chopping debris and breaking soil clods.
